(19) United States
(12) Patent Application Publication
(10) Pub. No.: US 2010/0211253 A1
(43) Pub. Date: Aug. 19, 2010

(54) INTELLIGENT CONTINUOUS MONITORING SYSTEM FOR APPLICATION IN SHOCK ABSORBERS

(75) Inventors: Raul Manuel Pereira Morais Dos Santos, Vila Real (PT); Paulo Jorge Da Cruz Ventura, Leiria (PT); Carlos Daniel Henriques Ferreira, Leiria (PT); Antonio Luís Gomes Valente, Vila Real (PT); Carlos Fernando Couceiro de Sousa Neves, Leiria (PT); Manuel Jose Cabral dos Santos Reis, Vila Real (PT)

Correspondence Address: SUGHRUE MION, PLLC, 2100 PENNSYLVANIA AVENUE, N.W., SUITE 800, WASHINGTON, DC, 20037, US

(73) Assignee: UNIVERSIDADE DE TRAS-OS-MONTES E ALTO DOURO, Vila Real (PT)

(21) Appl. No.: 12/682,185

(22) PCT Filed: Oct. 9, 2008
(86) PCT No.: PCT/PT08/00039

§ 371 Date: Apr. 8, 2010

(30) Foreign Application Priority Data
Oct. 10, 2007 (PT) PT 103847

(51) Int. Cl. G01M 17/04; G06F 15/00

(52) U.S. Cl. 701/29; 73/11.07; 702/182

(57) ABSTRACT

The present invention relates to a continuous monitoring system for shock absorbers, for use in motor vehicles or in any kind of machine which requires them, which will enable the shock absorbers to be evaluated during normal operation. It is essentially characterised by all the necessary components being embedded into the shock absorber itself, in a single circuit 1 or several integrated interconnected circuits, which are equipped with means of identification which provide the vehicle's or machine's various electronic management systems with the necessary information regarding shock absorbers identification, characteristics and capacity for self-diagnosis. The aforementioned components include acceleration, pressure and temperature sensors 2, signal conditioning and processing circuits 3, a wireless communication system 4, power production 5 and storage system 7 and management electronics 6.

### TECHNICAL DOMAIN OF THE INVENTION

The present invention consists of a continuous shock absorber monitoring system through sensors, enabling a state alert to be given.

### REMIT OF THE INVENTION

The present invention consists of a continuous monitoring system for shock absorbers through sensors, enabling a state alert to be given. The proposed system will be part of the electronic management system belonging to the vehicle or machine to which the shock absorber is fitted, which may use an electrical conductor connection or a wireless connection, whether or not it is part of the vehicle's or machine's data communication network, and may be embedded into the shock absorber as an autonomous system which has its own power supply circuit, or may be attached outside the shock absorber, with just an internal pressure plug, obtaining energy from the vehicle or machine power supply to which it is fitted, or producing its own power, for instance through piezoelectric converters using the energy absorbed by the shock absorber.

### BACKGROUND TO THE INVENTION

A motor vehicle's suspension is designed with the aim of achieving an acceptable compromise between comfort and the vehicle's dynamic performance.

Like any other mechanical' system, the suspension's components are subject to gradual ageing, particularly the shock absorbers, which owing to their physical design are greatly affected by wear, bleeding and the loss of qualities of the oil inside the shock absorber. This leads to a suspension which has negative effects on the comfort and safety of the vehicle.

A degraded suspension results in excessive oscillation of the vehicle, by reducing the amount of contact between the tires and the road, and subsequently leads to less comfort, reduced dynamic safety and to poorer breaking performance.

In modern vehicles, where electronic diagnosis plays an increasingly important role, the ability to characterise the shock absorber is not only fundamental in identifying faults, but will also enable the optimisation of strategies to control the various different active safety systems, in order to achieve an optimum suspension performance.

Evaluating its characteristics in real time during its lifetime will enable a warning when it should ideally be replaced, and will thus allow for more comfortable and safer driving.

The condition of the shock absorbers is usually checked using two distinctive methods: a test on the vehicle or a dynamometer test. Using dynamometers entails removing the shock absorber from the vehicle so that it can be stimulated at different frequencies, thus obtaining its characteristic force/velocity diagrams. Tests performed with the shock absorber fitted into the vehicle involve the use of a platform tester tool built for especially this purpose to stimulate the suspension as a whole, in order to measure adhesion—the contact force between the tyre and the platform. The result is a good indicator of the state of the suspension system as a whole, but not a good indicator of the state of the shock absorber, although some affirm that it is possible to assess the performance of the shock absorber by a phase angle analysis.

Evaluating the state of the art allows us to find several known methods for assessment of the shock absorber condition: method entails using an accelerometer connected to the ends of the shock absorber, and an external processing unit connected to the accelerometers to calculate the damping factor. The accelerometers, part of the test machine, are fitted to the vehicle during the test. The patented system does not allow the shock absorbers to be tested during normal operation.

In document EP18959A1 the method employed involves using an accelerometer fitted to the wheel hub, and determines the state of the shock absorber by comparing the damping between the expansion and compression phases of the shock absorber, performing a time domain analysis. The proposed system does not enable a check on all the types of anomalies/faults to which the shock absorbers are subject.

In document US2004217853A1 and EP1106397A2 the method employed entails a system attached to the tyre, which is capable of monitoring its pressure as well as the radial and lateral accelerations in order to determine the wear and tear on the tyre, its balance, and the state of the shock absorber. The state of the shock absorber is determined by comparing the FFT of the tyre's radial acceleration with a pre-set result for a new shock absorber. The proposed system does not effectively determine the state of the shock absorber—for example, it does not consider the type of stimulation to which the shock absorber is subject.

In document RU2284023C1 the method used entails a system whereby accelerometers are fitted to a vehicle's suspended and non-suspended masses. The suspension is stimulated at a frequency close to or equal to the resonance frequency of the wheels. The state of the shock absorbers is then determined by performing an average analysis of the accelerations ratio over the time. It is different from the proposed system because it is external both to the vehicle and to the machine, and neither enables continuous monitoring nor real time monitoring.

The method described in document US005525960A uses a device to measure the displacements between the moving part of the shock absorber in order to determine the state of the tyres and of the shock absorber. The proposed system does not take into account the external stimulation conditions to which the shock absorber is subject.

Based on the above, it can be seen that there is a need for an application which is able to provide to the driver a real-time indication of the state of the shock absorbers, regardless of their kind of use or road condition.

### SUMMARY OF THE INVENTION

The present invention consists of a continuous monitoring system for shock absorbers through sensors, thus enabling a state alert to be given. More specifically, the invention aims to provide a continuous monitoring system for shock absorbers, for use in motor vehicles or in any kind of machine which requires them, which will enable the shock absorbers condition to be assessed during normal operation. It is essentially characterised by all the necessary components being incorporated into the shock absorber itself, in a single or several interconnected integrated circuits, which are equipped with means of identification which provide the vehicle's or machine's various management systems with the necessary information regarding identification, characteristics and capacity for self-diagnosis.

The proposed system is highly feasibility and allows a high volume of production at low cost by using of Micro-Electro-Mechanical Systems (MEMS) which enables all the necessary components (sensors, signal conditioning circuits, wireless communication system, power production system and management electronics) to be included into a single integrated circuit, namely using CMOS technology.

This new system will enable automobile manufacturers to provide their customers with a technologically advanced solution for monitoring an essential component in automobile safety. Therefore, since there isn't currently any similar device, the present system will indicate the state of the shock absorbers continuously or when requested by any vehicle diagnostic/control unit or by any automobile diagnostic equipment. One hypothetical scenario for the system use is a warning alert regarding the state of the shock absorbers whenever the driver is getting ready, to start up the engine, for vehicle utilization. The driver will be able to be warned about the state of the shock absorbers via luminous, audible or other devices, which may either be dedicated to this system or an integral part of the vehicle's other diagnostic systems.

The use of this system will enable an evaluation of the state of each shock absorber whilst the vehicle is in normal operation and not only when the vehicle is undergoing to official periodic inspections or when the user decides to take it to the garage (where most of the tests done, with a ground platform tester, only indicate the state of the suspension as a whole and not the condition of the shock absorbers).

### BRIEF DESCRIPTION OF THE DRAWINGS

The following description is based on the drawings annexed, which are not in any way limited, and represent:

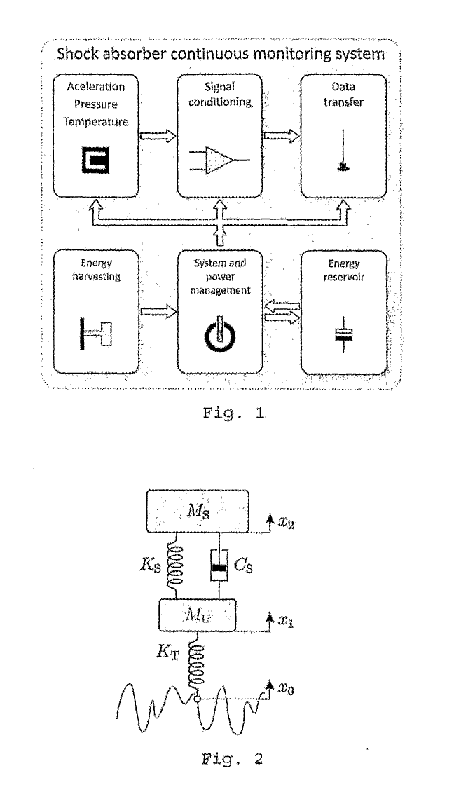

In FIG. 1, a possible diagram for the integrated system circuit; and

In FIG. 2, a diagram explanation of the variables involved in a typical suspension shock absorber system.

### DETAILED DESCRIPTION OF THE INVENTION

The present invention consists of a continuous monitoring system for shock absorbers through sensors, enabling a state alert to be given.

The use of Micro-Electro-Mechanical Systems (MEMS) enables all the necessary components such as sensors, signal conditioning circuits, wireless communication system, energy harvesting, power and system management electronics, to be integrated into a single integrated circuit 1, as exemplified in FIG. 1.

The aforementioned integrated circuit 1 can be manufactured using CMOS technology or other similar technology.

More specifically, the present invention consists of fitting the shock absorber with an integrated circuit 1 which includes acceleration, pressure and temperature sensors 2, and other devices for signal conditioning circuits 3, wireless communication systems 4, power production systems 5 and management electronics 6 and a energy storage unit 7. As can be seen from the figure, these devices included into a single integrated circuit 1 are connected to each other with one- or two-way connections.

The power production 5 and energy storage system and the management electronics 6 may be an autonomous system.

A—In the event that it entails independence from the standpoint of power source, it may have its own power source, separate from the vehicle's power system, or may harvest energy from the vehicle using appropriate methods.
B—In the event that it entails the physical independence of the production, storage and control system circuit with regard to the instrumentation, signal conditioning, processing and transmission systems circuits. Where power is produced, stored and managed separately from the instrumentation, signal conditioning, processing and transmission systems, there will be external interconnections with the aforementioned circuits.

Other configurations are also possible.

The system which is the subject of the patent application envisages two distinct modes of execution, both of which are capable of ascertaining the state of the shock absorbers.

The first mode of execution consists of installing two integrated circuits fitted to the body (chambers pat) and shaft part of each shock absorber whose sensors enable the temperature and acceleration to be measured. It is thus possible to measure the temperature and acceleration on both parts of each shock absorber, thereby eliminating the need to connect the sensor to the shock absorber's high pressure chamber and enabling electrical power production to be optimised using energy harvesting techniques.

The second configuration proposed consists of applying a single integrated circuit fitted to a single point on the body of the shock absorber. This circuit is capable of measuring the acceleration of the suspended mass or of the non-suspended mass, depending on how the shock absorber is assembled, the fluid/oil/air/gas pressure of the shock absorber upon the expansion (or compression or reservoir) chamber and the fluid/oil temperature, thereby enabling the state of the shock absorbers to be calculated by determining the correlation between pressure and acceleration. This circuit can also be used in the former mode of execution, providing that the pressure reading is not considered.

Solving the suspension system's equations in the frequency domain will enable the computation of the transmissibility, transfer function between accelerations in the suspended and non-suspended mass, as a function of the damping factor, spring constant of the suspension and suspended mass, where the transmissibility is calculate in the frequency range of interest, which may vary according to the characteristics of the vehicles or machines, function of the shock absorber's damping factor.

Considering the simplified linear model in FIG. 2 for the analytical study of the suspension behaviour, the suspension system on each wheel is simplified to a spring and a shock absorber in parallel, interconnecting the suspended mass and the non-suspended mass.

Since temperature is a parameter which directly influences damping characteristics, its correlation with the calculated transmissibility enables the state of the shock absorber to be more accurately determined.

The equations for the system which is diagrammatically represented in FIG. 2 are:

Equations for the spring/mass system −¼ of the vehicle

$$\{ \begin{matrix}{M}_{S} {\ddot{x}}_{2} = {K}_{S} ( {x}_{1} - {x}_{2} ) + {C}_{S} ( {\dot{x}}_{1} - {\dot{x}}_{2} ) \\ {M}_{U} {\ddot{x}}_{1} = {K}_{T} ( {x}_{0} - {x}_{1} ) - {K}_{S} ( {x}_{1} - {x}_{2} ) - {C}_{S} ( {\dot{x}}_{1} - {\dot{x}}_{2} )\end{matrix}$$

where:
M_{S}—Sprung mass
M_{U}—Unsprung mass
K_{S}—Spring constant
K_{T}—Tyre constant
C_{S}—Damping factor
x₀—Stimulation
x₁—Displacement of the wheel
x₂—Displacement of the vehicle body

The transmissibility, ratio between the amplitude of the acceleration transmitted via the existing connection and the amplitude of the acceleration of the stimulation, will enable the assessment of the shock absorber damping factor.

The transmissibility equation in the frequency domain is:

$$Transmissibility = \frac{{\ddot{x}}_{2} ( ω )}{{\ddot{x}}_{1} ( ω )}$$

Solving the presented system of equations for the mass-spring system enables the transmissibility to be calculated as a function of the parameters: Cₛ, Kₛ and Mₛ. In the frequency range at which stimulation is maximum, the transmissibility is, for the most part, determined by the value of C.

Thus, the practical measurement of transmissibility enables a conclusion to be drawn regarding the shock absorbers damping factor, since this is a direct indicator of the condition of the shock absorber.

In order to increase its interoperability with the vehicle's or machine's electronic elements, the system will be endowed with an electronic data sheet identification, capable of inform the vehicle's or machine's different management systems with the necessary information regarding identification, characteristics and capabilities for self-diagnosis. The interoperability of the shock absorber with the vehicle or machine may be achieved in two ways:

1. By determining the state of the shock absorber through the monitoring system itself which is embedded into the shock absorber, with information transmitted to the vehicle's processing system (wired or wireless connection);
2. By sending the information gathered by the system's sensors to the vehicle's electronic processing unit, where data is processed and the state of the shock absorber evaluated.
Lisbon, 9 Oct. 2008

1. Continuous monitoring system for shock absorbers, for use in motor vehicles or in any kind of machine which requires them, which will enable the shock absorbers to be tested during normal operation, characterised by all the necessary components being incorporated into the shock absorber itself, in a single circuit 1 or several integrated interconnected circuits, which are equipped with means of identification to provide the vehicle's or machine's various management systems with the necessary information regarding shock absorbers identification, characteristics and capacity for self-diagnosis.

2. Continuous monitoring system for shock absorbers, in accordance with claim 1, characterised by the integrated circuit 1 being manufactured using a low-cost integrated circuit technology, such as CMOS or other similar.

3. Continuous monitoring system for shock absorbers in accordance with claim 1, characterised by the aforementioned circuit components being sensors 2, signal conditioning and processing circuits 3, wireless communication system 4, power production 5 and storage system 7 and management electronics 6.

4. Continuous monitoring system for shock absorbers in accordance with claim 3, characterised by power production 5 and storage system 6 and management electronics 6 capable of being autonomous.

5. Continuous monitoring system for shock absorbers in accordance with claim 1, characterised by the aforementioned sensors measuring acceleration, temperature and pressure.

6. Continuous monitoring system for shock absorbers in accordance with claim 1, characterised by the interoperability of the shock absorber with the vehicle or machine being achieved by:
ascertaining the state of the shock absorber via the monitoring system itself which is incorporated into the shock absorber, with this information transmitted to the vehicle's diagnostic system via a connection which has wires or is wireless; or
sending the information gathered by the system's sensors to a vehicle's processing unit, where the state of the shock absorber can be computed from the received data.

7. Continuous monitoring system for shock absorbers in accordance with claim 1, characterised by including two integrated circuits fitted to the body (chambers part) and shaft part of each shock absorber whose sensors enable the temperature and acceleration of each shock absorber to be measured.

8. Continuous monitoring system for shock absorbers in accordance with claim 1, characterised by including a single integrated circuit capable of measuring acceleration, pressure and temperature, fitted to a single point on the body of the shock absorber.

9. Continuous monitoring system for shock absorbers in accordance with claim 7, characterised by solving the suspension system's equations in the frequency domain which will enable the computation of the transmissibility, transfer function between accelerations in the suspended and non-suspended mass, as a function of the damping factor, spring constant of the suspension and suspended mass, where the transmissibility is calculate in the frequency range of interest, which may vary according to the characteristics of the vehicles or machines, function of the shock absorber's damping factor.

10. Continuous monitoring system for shock absorbers in accordance with claim 8, characterised by—using just one integrated circuit whose sensors measure the pressure of the shock absorber's fluid/oil/air/gas upon expansion or compression or reservoir chamber's and the acceleration of the suspended mass or of the non-suspended mass, depending on how the shock absorber is fitted—the calculation of the state of the shock absorbers being obtained via the correlation between pressure and acceleration in the frequency domain.

11. Continuous monitoring system for shock absorbers in accordance with claim 10, characterised by, since fluid/oil temperature is a parameter which influences the damping characteristics, its correlation with the calculated condition enables the state of the shock absorber to be more accurately determined.
